(19) United States
(12) Patent Application Publication
(10) Pub. No.: US 2025/0014611 A1
(43) Pub. Date: Jan. 9, 2025

(54) Method for Multilingual Voice Translation

(71) Applicant: Vincent Loccisano, Wellesley, MA (US)

(72) Inventor: Vincent Loccisano, Wellesley, MA (US)

(21) Appl. No.: 18/889,588

(22) Filed: Sep. 19, 2024

(51) Int. Cl. G11B 27/036; G06F 40/58; G06V 20/40; G10L 15/02; G10L 25/57

(52) U.S. Cl. CPC G11B 27/036; G06F 40/58; G06V 20/49; G10L 15/02; G10L 25/57

(57) ABSTRACT

A method for generating dubbed speech in the voice of an original actor in a piece of video content is disclosed. Artificial intelligence (AI) is employed to extract sounds of an original actor's voice in a first language from other sounds and to generate a script. The extracted language sounds are divided into a plurality of sound identifiers, applied to a script in a second language and combined with the other sounds to replace an actor's voice in a first language with the actor's voice in a second language.

### TECHNICAL FIELD

The present disclosure relates generally to devices, systems and methods for acquiring audio of a specific person's voice in a first language, duplicating the characteristic sound of the voice and reproducing the same voice in a second language. The present disclosure further relates to capturing facial movements of the specific person's face while speaking in a first language and to animating video facial movements to align with a translated voice sound.

### BACKGROUND OF THE INVENTION

Subtitles or dubbing video content is expensive and time consuming. Commonly, dubbing is performed by a similar but different actor. A male actor may be dubbed by another male actor of a similar age but not by the same actor. An actor's voice is often an important part of character development. Changing the character's voice changes the overall effect of the video content.

Prosody is the elements of speech that are not individual phonetic segments but which are properties of syllables and larger units of speech and linguistic functions such as intonation, stress and rhythm. Such elements are also referred to as sound identifiers. Prosody reflects the emotional features of a speaker, their underlying emotional state, if they are making statements, commands or interrogatories; or if the speaker is speaking with irony or sarcasm, for example.

Many physical prosodic properties may be objectively measured. The sound wave and physiological characteristics of articulation may also be measured objectively. Objectively measured prosodic properties and sound wave characteristics, are sound identifiers that may be replicated.

Major prosodic variables include pitch of the voice, length of sounds, volume and variations between soft and loud, and timbre of the sound. These variables correspond closely to fundamental frequency, measured in hertz, duration, measured in milliseconds, intensity, measured in decibels, and spectral characteristics measured by the distribution of energy at different parts of the audible frequency range. In other words, the shape of a soundwave measured over time is an important sound identifier that can be objectively measured and replicated.

By replicating objectively measured prosodic properties as well as the sound wave of an actor's voice, the sound of the voice may be replicated. This process is also referred to as voice cloning. Voice cloning is the process of replicating or synthesizing a person's voice from audio samples. The result is a digital replica of the original voice which may be used to generate speech from text.

Replacing the spoken word in a second language using artificial intelligence in an original actor's voice would decrease the cost and labor of the dubbing of video content while preserving the quality of an actor's voice in the video content.

In the realm of digital media and film production, accurately synchronizing an actor's lip movements with newly recorded speech, such as in dubbing, voice replacement, or language translation, has long posed a technical challenge. Traditionally, reshooting scenes or relying on manual animation techniques were required to ensure the actor's lip movements matched the altered speech, which was often labor-intensive, time-consuming, and costly. As digital technologies evolved, so did the need for more efficient methods to manipulate mouth movements without reshooting or manual intervention.

Recent advancements in computer vision, artificial intelligence (AI), and machine learning have enabled the development of automated systems that can capture, analyze, and duplicate an actor's facial expressions and lip movements in real time. These systems can then be reanimated to correspond to new speech inputs while maintaining the integrity of the original performance. This allows for seamless dubbing, re-voicing, and even creative applications like altering performances or generating entirely new dialogue, all while preserving the actor's original visual appearance. Such technology has applications in the entertainment industry, including film, television, gaming, and virtual reality, as well as in marketing, training, and educational content.

Existing solutions often struggle with achieving a naturalistic appearance in real-time applications, maintaining synchronization under varying lighting conditions, and ensuring the actor's full range of emotions is captured. Therefore, there is a need for a more precise and efficient method for duplicating and reanimating mouth movements to match altered speech while maintaining the authenticity of the performance, in the original actor's voice and facial movements.

### SUMMARY OF THE INVENTION

A method for generating dubbed speech in the voice of an original actor in a piece of video content is disclosed. Artificial intelligence (AI) is employed to extract sounds of an original actor's voice in a first language from background noise. The extracted language sounds are divided into a plurality of sound identifiers. Sound identifiers include but are not limited to prosodic content such as frequency, duration, intensity and the overall shape of a sound wave of the actor's voice sounds, measured over time. These sound identifiers may also be referred to as pitch, length of sounds, volume and variations between soft and loud and timbre, and sound wave peaks and valleys at specific times.

The overall shape of a sound wave of the actor's voice may be derived by various methods. Sampling is the reduction of a continuous-time signal to a discrete-time signal. In the field of music and audio recording, a sample is a value of a signal at a point in time. A sampler is a system or operation that extracts samples from a continuous signal. A theoretical ideal sampler produces samples equivalent to the instantaneous value of the continuous signal at a desired point in time.

An Artificial Intelligence component of the method involves extracting and duplicating a specific person's voice from an audio file. The audio file may be an audio/visual combination or a separate audio component. In other words, the audio file may be combined with a movie or video, or may be a separate file containing audio only. AI duplicates a voice by analyzing and modeling the unique characteristics of that voice using machine learning techniques. The process begins with gathering a substantial amount of audio data from the target speaker, which captures various elements such as pitch, tone, cadence, and pronunciation. This data is then fed into a neural network trained on speech patterns and vocal nuances. The AI uses this training to create a model that can replicate the speaker's voice with high fidelity, generating new speech that mimics the original voice's distinctive qualities. Advanced algorithms also incorporate contextual understanding and emotional nuances to make the synthetic voice sound more natural and authentic.

AI used in the method of the disclosure, derives text from speech through a process known as automatic speech recognition (ASR). This involves converting spoken language into written text using complex algorithms and machine learning models. Initially, the AI system processes audio input to break it down into smaller, manageable units called phonemes, which are the basic sounds of speech. The system then uses a pre-trained neural network to analyze these phonemes and match them with corresponding words or phrases based on context and language patterns. By leveraging vast datasets of spoken language, the AI can improve its accuracy over time, recognizing various accents, dialects, and speech patterns to generate text that accurately reflects the spoken content.

A sound wave shape is derived from various methods. A sound wave's shape is created by the way a person's voice interacts with the environment as they speak. When a person talks, their vocal cords vibrate, producing sound waves. These vibrations cause the air around the vocal cords to move, creating pressure fluctuations that travel through the air. The shape and characteristics of these sound waves are influenced by the vocal tract's unique configuration, including the throat, mouth, and nasal passages. As the sound waves move through these resonating chambers, they are shaped by articulatory movements—such as how the tongue and lips are positioned—which affects the frequency and amplitude of the sound. These vibrations and modifications result in the distinct waveform that represents a person's voice, capturing its tone, timbre, pitch, volume, and rate. In some embodiments the voice characteristic sound further represents accent, speech pattern and idiosyncrasies. Idiosyncrasies may include pauses, clicking of the tongue, time extending sounds such as “um” “ah” or “you know” that are commonly used in casual speech. One skilled in the art understands that each language may have its own common phrases similarly used to fill time. The combination of these factors creates a unique acoustic signature that characterizes each individual's voice and is referred to as a voice characteristic sound. The voice characteristic sound further comprises.

Extracted sounds evaluated as to their prosodic characteristics are combined with a script of the actor's spoken word in the original language. The script is translated into a second language using AI. The prosodic characteristics are applied to the script in the second language wherein the sounds of the actor's voice may be heard in the second language. The sound of the actor's voice in the second language is then replaced into the original file including other speakers, background noise and the like. The result is an actor's voice in a second language in the original video content.

Duplicating an actor's mouth movement to reanimate it with altered speech in a video involves a process called “lip-syncing” or “facial reanimation.” This technique captures the actor's original facial expressions, particularly the mouth movements, during their speech. Advanced software is used to track and map these movements, then replicate them frame by frame. Once the original movement is captured, animators can modify the lip movements to match new dialogue while keeping the rest of the facial expressions intact. This method allows for a translated audio with matched facial movements.

An example method for duplicating media with translated speech corresponding to an input media file employs a computer to execute the steps of acquiring an input media file including the voice of a specific person, often an actor, speaking in a first language. The method continues by deriving an input script of the actor's spoken word. Further, the method continues by acquiring the actor's voice characteristic sound. A voice characteristic sound includes various prosodic characteristics and may include a combination of tone, timbre, pitch, volume and rate. A voice characteristic sound may also be defined by frequency measured in hertz, duration measured in time increments, intensity measured in decibels or a sound wave shape, also referred to as a wave form. In some embodiments, the voice characteristic sound is defined by a wave form. In other embodiments the sound of the actor's voice is divided into a plurality of sound identifiers from the audio file in the first language. After defining the actor's voice in this way the method continues by translating the input script into a second language to generate an output script. The actor's voice characteristic sound, including sound identifiers, is combined with the output script and the result is an actor's voice in a second language in the original video content.

In some embodiments the actor's voice, translated into a second language in the same actor's voice, is coupled with a video adaptation of the actor's facial movements to complete the experience of seeing the actor speaking in a second language. The method further includes acquiring the input media file including a video of the actors voice and face, speaking in the first language. The actor's facial movements are separated into individual phonetic pronunciation video segments of speech in the first language. The method continues by assembling phonetic pronunciation according to the duplicate media with translated speech and then by generating duplicate media with translated speech and facial movements of the actor.

Artificial intelligence is used to derive speech sounds from non-speech sounds. Non-speech sounds refers to background noise, music, other's speaking and the like. One skilled in the art understands that multiple actors speaking would all be translated using the method.

Although the method may be employed when creating a new audio/visual product, the method also works when translating a prior published work.

### BRIEF DESCRIPTION OF DRAWINGS

FIG. 1 is a diagram of the method of the disclosure.

FIG. 2 is a diagram illustrating an iteration of the method of FIG. 1.

FIG. 3 is a diagram illustrating an iteration of the method of FIG. 2.

### DETAILED DESCRIPTION

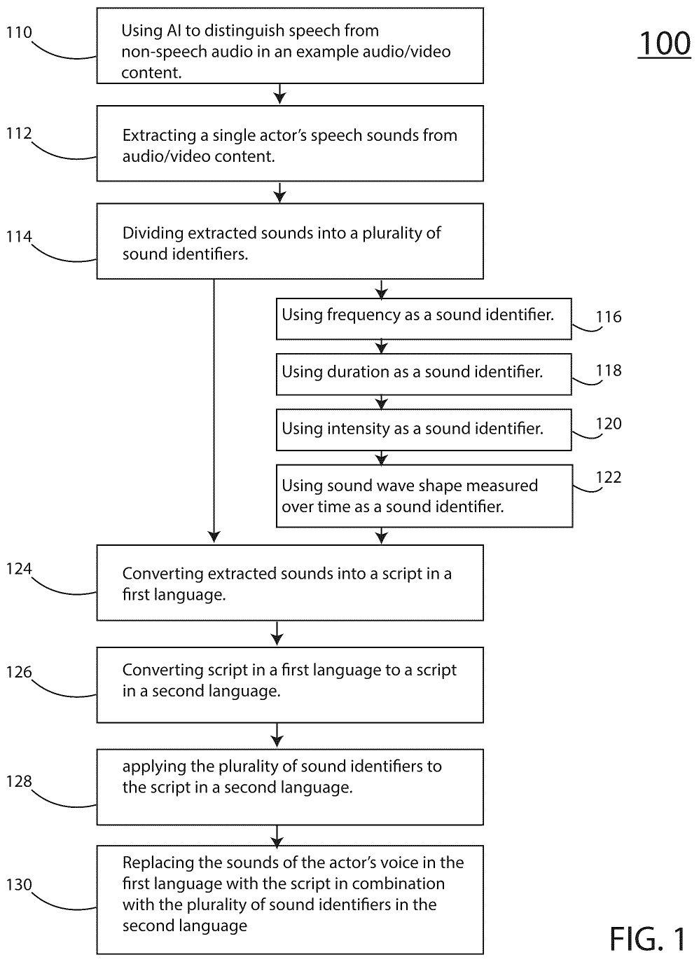

Referring to FIG. 1, a diagram illustrates a method 100 whereby the speech of an actor in a first language is replaced by speech in a second language in the actor's voice. Artificial intelligence is used to distinguish speech from non-speech in an audio/visual sample 110. The method follows by extracting a single actor's speech sounds from the audio/video content 112 and follows further by dividing extracted sounds into a plurality of sound identifiers 114. In some embodiments sound identifiers include frequency 116, duration 118, intensity 120, and sound wave shape measured over time 122. The method further follows by converting extracted sounds into a script in a first language 124 and follows by converting the script in the first language into a script in a second language 126. A following step includes applying the plurality of sound identifiers to the script in a second language 128, thus recreating the sound of the actor's voice in the second language. The method concludes by replacing the sounds of the actor's voice in the first language with the same script in combination with the plurality of sound identifiers in the second language, thus recreating the actor's voice in the second language 130.

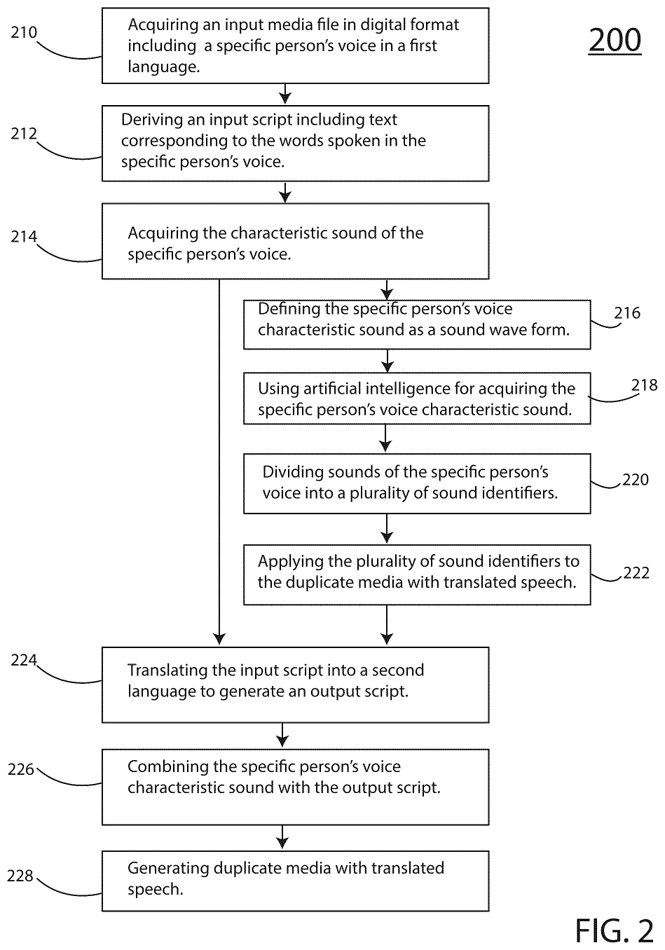

Referring to FIG. 2, a diagram illustrates an iteration 200 of the method of FIG. 1, whereby the speech of an actor in a first language is replaced by speech in a second language in the actor's voice. The method begins by acquiring an input media file in a digital format that includes a specific person's voice in a first language 210. The method continues by deriving an input script including text corresponding to the words spoken in the specific person's voice 212. The method continues by acquiring the characteristic sound of the specific person's voice 214. In some embodiments the method proceeds by defining the specific persons voice characteristic as a sound wave form 216. Further using artificial intelligence for acquiring the specific person's voice characteristic sound 218. The method continues by dividing sounds of the specific person's voice into a plurality of sound identifiers 220, and applying the plurality of sound identifiers to the duplicate media with translated speech 222. In other embodiments the method follows the step of acquiring the characteristic sound of the specific person's voice 214, by translating the input script into a second language to generate an output script 224. The method further continues by combining the specific person's voice characteristic sound with the output script 226. The method concludes by generating duplicate media with translated speech 228.

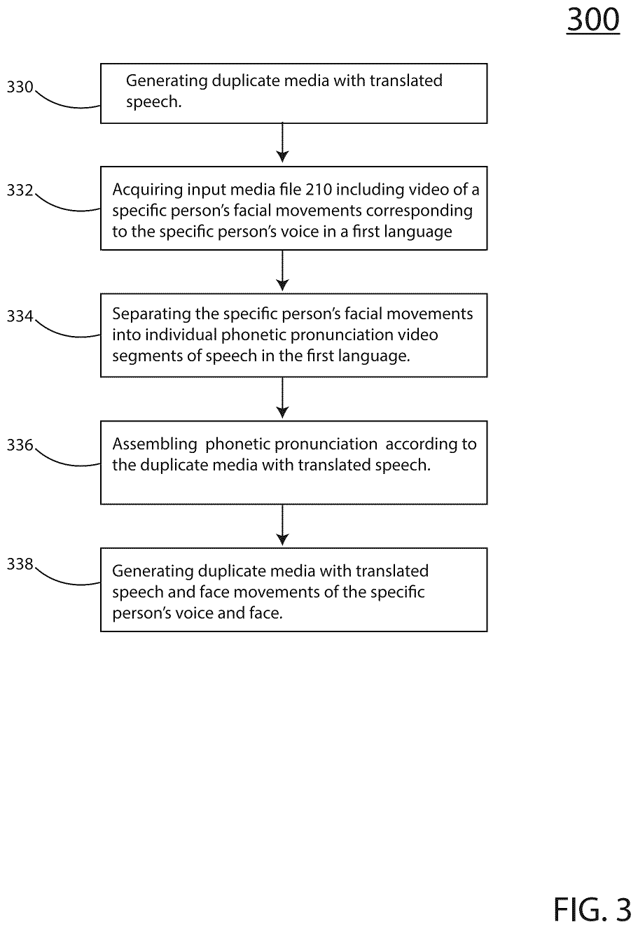

Referring to FIG. 3, a diagram illustrates an iteration 300 of the method of FIG. 2 whereby the facial movements of the same actor, speaking in a first language is reanimated to correspond to the same actor's speech and corresponding facial movements in the second language. The method begins with the final step of the method of FIG. 2, Generating duplicate media with translated speech 330, and follows by acquiring input media file 210 including video of a specific person's facial movements corresponding to the specific person's voice in a first language 332. The method then continues by separating the specific person's facial movements into individual phonetic pronunciation video segments of speech spoken in the first language 334. The method proceeds by assembling phonetic pronunciation according to the duplicate media with translated speech 336 and concludes by generating duplicate media with translated speech and face movements of the specific person's voice and face.

1. A method for duplicating media with translated speech corresponding to an input media file comprising:
at least one processor; and
memory including instruction that, when executed by the at least one processor, perform a method comprising:
acquiring the input media file, including audio in digital format, in a specific person's voice and in a first language; and
deriving an input script, wherein the input script includes text corresponding to the words spoken in the specific person's voice; and
acquiring the specific person's voice characteristic sound; and
translating the input script into a second language to generate an output script; and
combining the specific person's voice characteristic sound with the output script; wherein
duplicate media with translated speech corresponding to the input media file is generated.

2. The method of claim 1 wherein:
the voice characteristic sound comprises:
a combination of tone, timbre, pitch, volume and rate.

3. The method of claim 2 wherein:
the voice characteristic sound further comprises accent, speech pattern and idiosyncrasies.

4. The method of claim 1 wherein:
defining the specific person's voice characteristic sound as a sound wave form.

5. The method of claim 1 wherein:
the instructions included in the memory further perform a step of the method for;
using artificial intelligence for acquiring sounds of the specific person's voice in a first language from other sounds in the media file.

6. The method of claim 1 wherein:
the instructions included in the memory further perform a step of the method:
dividing the sounds of the specific person's voice into a plurality of sound identifiers in the first language.

7. The method of claim 5 further comprising:
applying the plurality of sound identifiers to the duplicate media with translated speech.

8. The method of claim 1 further comprising;
acquiring the input media file including a video, in digital format, of the specific person's voice and face speaking in the first language; and
separating the specific person's facial movements into individual phonetic pronunciation video segments of speech in the first language; and
assembling phonetic pronunciation according to the duplicate media with translated speech; and
generating duplicate media with translated speech and face movements of the specific person's voice and face.

9. A computer implemented method for generating dubbed speech in the voice of an actor, the method comprising:
using artificial intelligence to extract sounds of the actor's voice in a first language from one or more audio samples; and
dividing extracted sounds into a plurality of sound identifiers; and
converting the actor's voice into a script in the first language; and
converting the script in the first language into a script in a second language; and
applying the plurality of sound identifiers to the script in a second language; and
replacing the sounds of the actor's voice in the first language with the script in combination with the plurality of sound identifiers in the second language; wherein
the dubbed speech is the voice of the actor, spoken in the second language.

10. The method of claim 9 further comprising:
using artificial intelligence to derive speech sounds from non-speech sounds.

11. The method of claim 9 wherein:
the plurality of sound identifiers include frequency measured in hertz.

12. The method of claim 9 wherein:
the plurality of sound identifiers include duration, measured in time increments.

13. The method of claim 8 wherein:
the plurality of sound identifiers include intensity, measured in decibels.

14. The method of claim 9 wherein:
the plurality of sound identifiers includes sound wave shape measured over time.

15. A method for duplicating media with translated speech corresponding to an input media file comprising:
at least one processor; and
memory including instruction that, when executed by the at least one processor, perform a method comprising:
acquiring the input media file, including audio in a specific person's voice and video of the same person's face, in digital format, and in a first language; and
deriving an input script, wherein the input script includes text corresponding to the words spoken in the specific person's voice; and
separating the specific person's facial movements into individual phonetic pronunciation video segments of speech in the first language; and
acquiring the specific person's voice characteristic sound; and
translating the input script into a second language to generate an output script; and
combining the specific person's voice characteristic sound with the output script; and
assembling phonetic pronunciation according to the duplicate media with translated speech; and
duplicate media with translated speech and matched facial movements, corresponding to the input media file is generated.

16. The method of claim 15 wherein:
the audio in a specific person's voice and video of the same person's face, are acquired from a prior published work in a first language; wherein
an audio/visual product is produced in a second language based on the prior published work.
